(19) United States
(12) Patent Application Publication
(10) Pub. No.: US 2023/0267947 A1
(43) Pub. Date: Aug. 24, 2023

(54) NOISE REDUCTION USING MACHINE LEARNING

(71) Applicant: Dolby Laboratories Licensing Corporation, San Francisco, CA (US)

(72) Inventor: Zhiwei SHUANG, Campbell, CA (US)

(73) Assignee: Dolby Laboratories Licensing Corporation, San Francisco, CA (US)

(21) Appl. No.: 18/007,005

(22) PCT Filed: Aug. 2, 2021
(86) PCT No.: PCT/US2021/044166

§ 371 Date: Jan. 26, 2023

Related U.S. Application Data
(60) Provisional application No. 63/110,114, filed on Nov. 5, 2020.
(60) Provisional application No. 63/068,227, filed on Aug. 20, 2020.

(30) Foreign Application Priority Data
Jul. 31, 2020 (WO) PCT/CN2020/106270
Nov. 11, 2020 (EP) 20206921.7

(51) Int. Cl. G10L 21/0364; G10L 25/84; G10L 21/0232; G10L 25/18; G10L 21/034

(52) U.S. Cl. CPC G10L 21/0364; G10L 25/84; G10L 21/0232; G10L 25/18; G10L 21/034; G10L 25/30

(57) ABSTRACT

A method of noise reduction includes using a neural network to control a Wiener filter. The gains estimated by the neural network are combined with the gains produced by the Wiener filter. In this manner, the noise reduction system provides improved results as compared to using only a neural network.

### CROSS REFERENCE TO RELATED APPLICATIONS

This application claims the benefit of priority to European Patent Application No. 20206921.7, filed Nov. 11, 2020, U.S. Provisional Patent Application No. 63/110,114, filed Nov. 5, 2020, U.S. Provisional Patent Application No. 63/068,227, filed Aug. 20, 2020, and International Patent Application No. PCT/CN2020/106270, filed Jul. 31, 2020, all of which are incorporated herein by reference in their entirety.

### FIELD

The present disclosure relates to audio processing, and in particular, to noise reduction.

### BACKGROUND

Unless otherwise indicated herein, the approaches described in this section are not prior art to the claims in this application and are not admitted to be prior art by inclusion in this section.

Noise reduction is challenging to implement in mobile devices. The mobile device may capture both stationary and non-stationary noise in a variety of use cases, including voice communications, development of user generated content, etc. Mobile devices may be constrained in power consumption and processing capacity, resulting in a challenge to develop noise reduction processes that are effective when implemented by mobile devices.

### SUMMARY

Given the above, there is a need to develop a noise reduction system that works well in mobile devices.

According to an embodiment, a computer-implemented method of audio processing includes generating first band gains and a voice activity detection value of an audio signal using a machine learning model. The method further includes generating a background noise estimate based on the first band gains and the voice activity detection value. The method further includes generating second band gains by processing the audio signal using a Wiener filter controlled by the background noise estimate. The method further includes generating combined gains by combining the first band gains and the second band gains. The method further includes generating a modified audio signal by modifying the audio signal using the combined gains.

According to another embodiment, an apparatus includes a processor and a memory. The processor is configured to control the apparatus to implement one or more of the methods described herein. The apparatus may additionally include similar details to those of one or more of the methods described herein.

According to another embodiment, a non-transitory computer readable medium stores a computer program that, when executed by a processor, controls an apparatus to execute processing including one or more of the methods described herein.

The following detailed description and accompanying drawings provide a further understanding of the nature and advantages of various implementations.

### BRIEF DESCRIPTION OF THE DRAWINGS

FIG. 1 is a block diagram of a noise reduction system 100.

FIG. 2 shows a block diagram of an example system 200 suitable for implementing example embodiments of the present disclosure.

FIG. 3 is a flow diagram of a method 300 of audio processing.

### DETAILED DESCRIPTION

Described herein are techniques related to noise reduction. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted (e.g., “either A or B”, “at most one of A and B”).

This document describes various processing functions that are associated with structures such as blocks, elements, components, circuits, etc. In general, these structures may be implemented by a processor that is controlled by one or more computer programs.

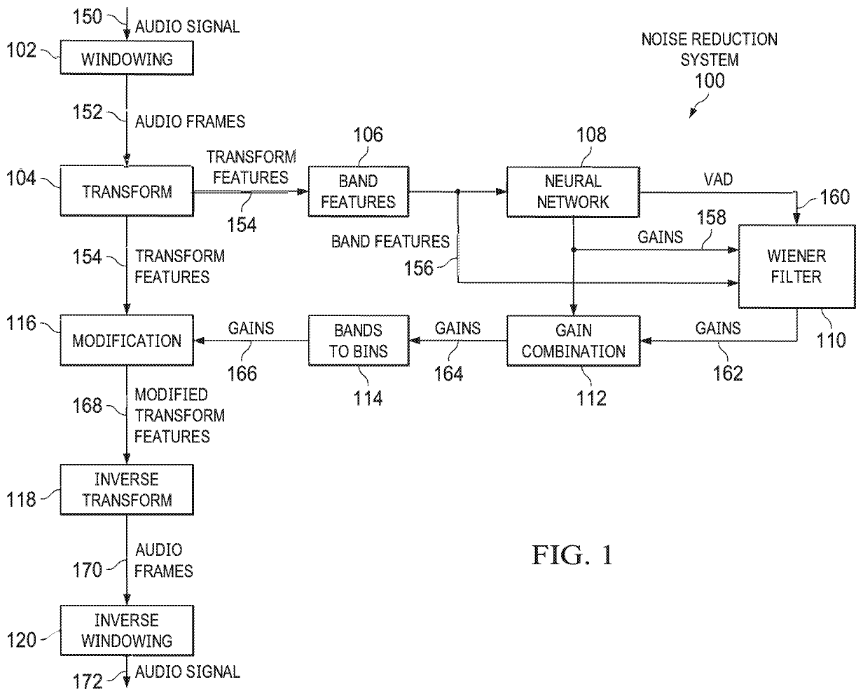

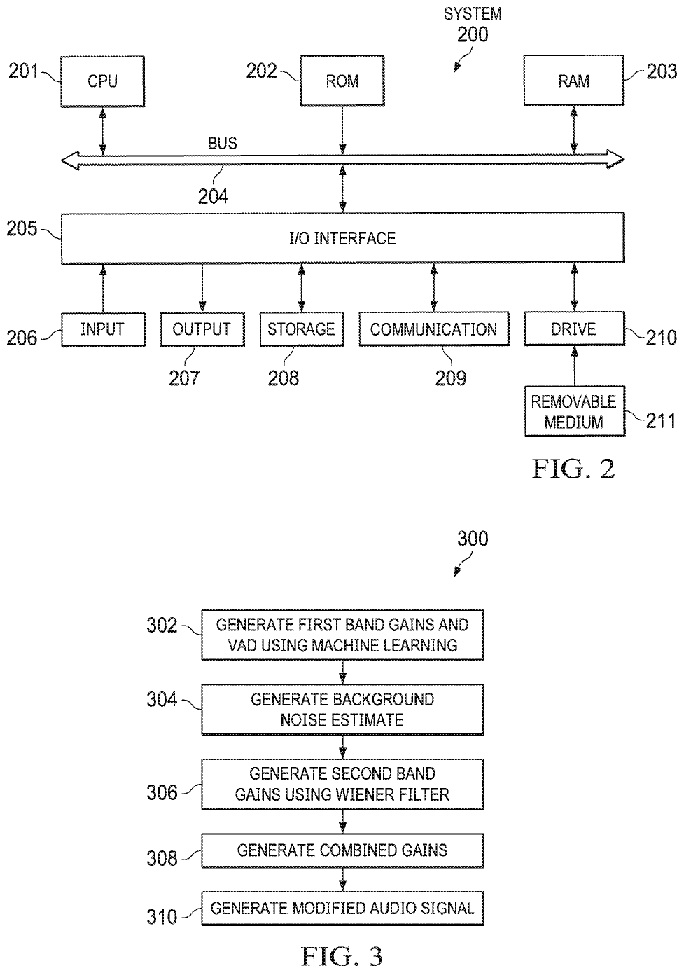

FIG. 1 is a block diagram of a noise reduction system 100. The noise reduction system 100 may be implemented in a mobile device (e.g., see FIG. 2), such as a mobile telephone, a video camera with a microphone, etc. The components of the noise reduction system 100 may be implemented by a processor, for example as controlled according to one or more computer programs. The noise reduction system 100 includes a windowing block 102, a transform block 104, a band features analysis block 106, a neural network 108, a Wiener filter 110, a gain combination block 112, a band gains to bin gains block 114, a signal modification block 116, an inverse transform block 118, and an inverse windowing block 120. The noise reduction system 100 may include other components that (for brevity) are not described in detail.

The windowing block 102 receives an audio signal 150, performs windowing on the audio signal 150, and generates audio frames 152. The audio signal 150 may be captured by a microphone of the mobile device that implements the noise reduction system 100. In general, the audio signal 150 is a time domain signal that includes a sequence of audio samples. For example, the audio signal 150 may be captured at a 48 kHz sampling rate with each sample quantized at a bit rate of 16 bits. Other example sampling rates may include 44.1 kHz, 96 kHz, 192 kHz, etc., and other bit rates may include 24 bits, 32 bits, etc.

In general, the windowing block 102 applies overlapping windows to the samples of the audio signal 150 to generate the audio frames 152. The windowing block 102 may implement various forms of windowing, including rectangular windows, triangular windows, trapezoidal windows, sine windows, etc.

The transform block 104 receives the audio frames 152, performs a transform on the audio frames 152, and generates transform features 154. The transform may be a frequency domain transform, and the transform features 154 may include bin features and fundamental frequency parameters of each audio frame. (The transform features 154 may also be referred to as the bin features 154.) The fundamental frequency parameters may include the voice fundamental frequency, referred to as FO. The transform block 104 may implement various transforms, including a Fourier transform (e.g., a fast Fourier transform (FFT)), a quadrature mirror filter (QMF) domain transform, etc. For example, the transform block 104 may implement an FFT with an analysis window of 960 points and a frame shift of 480 points; alternatively, an analysis window of 1024 points and a frame shift of 512 points may be implemented. The number of bins in the transform features 154 is generally related to the number of points of the transform analysis; for example, a 960-point FFT results in 481 bins.

The transform block 104 may implement various processes to determine fundamental frequency parameters of each audio frame. For example, when the transform is an FFT, the transform block 104 may extract the fundamental frequency parameters from the FFT parameters. As another example, the transform block 104 may extract the fundamental frequency parameters based on the autocorrelation of the time domain signals (e.g., the audio frames 152).

The band features analysis block 106 receives the transform features 154, performs band analysis on the transform features 154, and generates band features 156. The band features 156 may be generated according to various scales, including the Mel scale, the Bark scale, etc. The number of bands in the band features 156 may be different when using different scales, for example 24 bands for the Bark scale, 80 bands for the Mel scale, etc. The band features analysis block 106 may combine the band features 156 with the fundamental frequency parameters (e.g., FO).

The band features analysis block 106 may use rectangular bands. The band features analysis block 106 may also use triangular bands, with the peak response being at the boundary between bands.

The band features 156 may be band energies, such as Mel bands energy, Bark bands energy, etc. The band features analysis block 106 may calculate the log value of Mel band energy and Bark band energy. The band features analysis block 106 may apply a discrete cosine transform (DCT) conversion of the band energy to generate new band features, to make the new band features less correlated than the original band features. For example, the band features analysis block 106 may generate the band features 156 as Mel-frequency cepstral coefficients (MFCCs), Bark-frequency cepstral coefficients (BFCCs), etc.

The band features analysis block 106 may perform smoothing of the current frame and previous frames according to a smoothing value. The band features analysis block 106 may also perform a difference analysis by calculating a first order difference and a second order difference between the current frame and previous frames.

The band features analysis block 106 may calculate a band harmonicity feature, which indicates how much of the current band is composed of a periodic signal. For example, the band features analysis block 106 may calculate the band harmonicity feature based on FFT frequency bind of the current frame. As another example, band features analysis block 106 may calculate the band harmonicity feature based on the correlation between the current frame and the previous frame.

In general, the band features 156 are fewer in number than the bin features 154, and thus reduce the dimensionality of the data input into the neural network 108. For example, the bin features may be on the order of 513 or 481 bins, and the band features 156 may be on the order of 24 or 80 bands.

The neural network 108 receives the band features 156, processes the band features 156 according to a model, and generates gains 158 and a voice activity decision (VAD) 160. The gains 158 may also be referred to as DGains, for example to indicate that they are the outputs of a neural network. The model has been trained offline; training the model, including preparation of the training data set, is discussed in a subsequent section.

The neural network 108 uses the model to estimate the gain and voice activity for each band based on the band features 156 (e.g., including the fundamental frequency FO), and outputs the gains 158 and the VAD 160. The neural network 108 may be a full connected neural network (FCNN), a recurrent neural network (RNN), a convolutional neural network (CNN), another type of machine learning system, etc., or combinations thereof.

The noise reduction system 100 may apply smoothing or limiting to the DGains outputs of the neural network 108. For example, the noise reduction system 100 may apply average smoothing or median filtering to the gains 158, along the time axis, the frequency axis, etc. As another example, the noise reduction system 100 may apply limiting to the gains 158, with the largest gain being 1.0 and the smallest gain being different for different bands. In one implementation, the noise reduction system 100 sets a gain of 0.1 (e.g., −20 dB) as the smallest gain for the lowest 4 bands and sets a gain of 0.18 (e.g., −15 dB) as the smallest gain for the middle bands. Setting a minimum gain mitigates discontinuities in the DGains. The minimum gain values may be adjusted as desired; e.g., minimum gains of −12 dB, −15 dB, −18 dB, −20 dB, etc. may be set for various bands.

The Wiener filter 110 receives the band features 156, the gains 158 and the VAD 160, performs Weiner filtering, and generates gains 162. The gains 162 may also be referred to as WGains, for example to indicate that they are the outputs of a Wiener filter. In general, the Wiener filter 110 estimates the background noise in each band of the input signal 150, according to the band features 156. (The background noise may also be referred to as the stationary noise.) The Wiener filter 110 uses the gains 158 and the VAD 160 estimated by the neural network to control its filtering process. In one implementation, for a given input frame (having corresponding band features 156) without voice activity (e.g., the VAD 160 being less than 0.5), the Wiener filter 110 checks the band gains (according to the gains 158 (DGains)) for the given input frame. For bands with DGains less than 0.5, the Wiener filter 110 views these bands as noise frames and smooths the band energy of these frames to obtain an estimate of the background noise.

The Wiener filter 110 may also track the average number of frames used to calculate the band energy for each band to obtain the noise estimation. When the average number for a given band is greater than a threshold number of frames, the Wiener filter 110 is applied to calculate a Wiener band gain for the given band. If the average number for the given band is less than the threshold number of frames, the Wiener band gain is 1.0 for the given band. The Wiener band gains for each of the bands are output as the gains 162, also referred to as Wiener gains (or WGains).

In effect, the Wiener filter 110 estimates the background noise in each band based on the signal history (e.g., a number of frames of the input signal 150). The threshold number of frames gives the Wiener filter 110 a sufficient number of frames to result in a confident estimation of the background noise. In one implementation, the threshold number of frames is 50. When one frame is 10 ms, this corresponds to 0.5 seconds of the input signal 150. When the number of frames is less than the threshold, the Wiener filter 110 in effect is bypassed (e.g., the WGains are 1.0).

The noise reduction system 100 may apply limiting to the WGains outputs of the Wiener filter 110, with the largest gain being 1.0 and the smallest gain being different for different bands. In one implementation, the noise reduction system 100 sets a gain of 0.1 (e.g., −20 dB) as the smallest gain for the lowest 4 bands and sets a gain of 0.18 (e.g., −15 dB) as the smallest gain for the middle bands. Setting a minimum gain mitigates discontinuities in the WGains. The minimum gain values may be adjusted as desired; e.g., minimum gains of −12 dB, −15 dB, −18 dB, −20 dB, etc. may be set for various bands.

The gain combination block 112 receives the gains 158 (DGains) and the gains 162 (WGains), combines the gains, and generates gains 164. The gains 164 may also be referred to as band gains, combined band gains or CGains, for example to indicate that they are a combination of the DGains and the WGains. As an example, the gain combination block 112 may multiply the DGains and the WGains to generate the CGains, on a per-band basis.

The noise reduction system 100 may apply limiting to the CGains outputs of the gain combination block 112, with the largest gain being 1.0 and the smallest gain being different for different bands. In one implementation, the noise reduction system 100 sets a gain of 0.1 (e.g., −20 dB) as the smallest gain for the lowest 4 bands and sets a gain of 0.18 (e.g., −15 dB) as the smallest gain for the middle bands. Setting a minimum gain mitigates discontinuities in the CGains. The minimum gain values may be adjusted as desired; e.g., minimum gains of −12 dB, −15 dB, −18 dB, −20 dB, etc. may be set for various bands.

The band gains to bin gains block 114 receives the gains 164, converts the band gains to bin gains, and generates the gains 166 (also referred to as the bin gains). In effect, the band gains to bin gains block 114 performs an inverse of the processing performed by the band features analysis block 106, in order to convert the gains 164 from band gains to bin gains. For example, if the band features analysis block 106 processed 1024 points of FFT bins into 24 Bark scale bands, the band gains to bin gains block 114 converts the 24 Bark scale bands of the gains 164 into 1024 FFT bins of the gains 166.

The band gains to bin gains block 114 may implement various techniques to convert the band gains to bin gains. For example, the band gains to bin gains block 114 may use interpolation, e.g. linear interpolation.

The signal modification block 116 receives the transform features 154 (which include the bin features and the fundamental frequency FO) and the gains 166, modifies the transform features 154 according to the gains 166, and generates modified transform features 168 (which include modified bin features and the fundamental frequency FO). (The modified transform features 168 may also be referred to as the modified bin features 168.) The signal modification block 116 may modify the amplitude spectrum of the bin features 154 based on the gains 166. In one implementation, the signal modification block 116 will leave unchanged the phase spectrum of the bin features 154 when generating the modified bin features 168. In another implementation, the signal modification block 116 will adjust the phase spectrum of the bin features 154 when generating the modified bin features 168, for example by performing an estimate based on the modified bin features 168. As an example, the signal modification block 116 may use a short-time Fourier transform to adjust the phase spectrum, e.g. by implementing of the Griffin-Lim process.

The inverse transform block 118 receives the modified transform features 168, performs an inverse transform on the modified transform features 168, and generates audio frames 170. In general, the inverse transform performed is an inverse of the transform performed by the transform block 104. For example, the inverse transform block 118 may implement an inverse Fourier transform (e.g., an inverse FFT), an inverse QMF transform, etc.

The inverse windowing block 120 receives the audio frames 170, performs inverse windowing on the audio frames 170, and generates an audio signal 172. In general, the inverse windowing performed is an inverse of the windowing performed by the windowing block 102. For example, the inverse windowing block 120 may perform overlap addition on the audio frames 170 to generate the audio signal 172.

As a result, the combination of using the output of the neural network 108 to control the Wiener filter 110 may provide improved results over just using a neural network alone to perform noise reduction, as many neural networks operate using just a short memory.

FIG. 2 shows a block diagram of an example system 200 suitable for implementing example embodiments of the present disclosure. System 200 includes one or more server computers or any client device. System 200 include any consumer devices, including but not limited to smart phones, media players, tablet computers, laptops, wearable computers, vehicle computers, game consoles, surround systems, kiosks, etc.

As shown, the system 200 includes a central processing unit (CPU) 201 which is capable of performing various processes in accordance with a program stored in, for example, a read only memory (ROM) 202 or a program loaded from, for example, a storage unit 208 to a random access memory (RAM) 203. In the RAM 203, the data required when the CPU 201 performs the various processes is also stored, as required. The CPU 201, the ROM 202 and the RAM 203 are connected to one another via a bus 204. An input/output (I/O) interface 205 is also connected to the bus 204.

The following components are connected to the I/O interface 205: an input unit 206, that may include a keyboard, a mouse, a touchscreen, a motion sensor, a camera, or the like; an output unit 207 that may include a display such as a liquid crystal display (LCD) and one or more speakers; the storage unit 208 including a hard disk, or another suitable storage device; and a communication unit 209 including a network interface card such as a network card (e.g., wired or wireless). The communication unit 209 may also communicate with wireless input and output components, e.g., a wireless microphone, wireless earbuds, wireless speakers, etc.

In some implementations, the input unit 206 includes one or more microphones in different positions (depending on the host device) enabling capture of audio signals in various formats (e.g., mono, stereo, spatial, immersive, and other suitable formats).

In some implementations, the output unit 207 include systems with various number of speakers. As illustrated in FIG. 2, the output unit 207 (depending on the capabilities of the host device) can render audio signals in various formats (e.g., mono, stereo, immersive, binaural, and other suitable formats).

The communication unit 209 is configured to communicate with other devices (e.g., via a network). A drive 210 is also connected to the I/O interface 205, as required. A removable medium 211, such as a magnetic disk, an optical disk, a magneto-optical disk, a flash drive or another suitable removable medium is mounted on the drive 210, so that a computer program read therefrom is installed into the storage unit 208, as required. A person skilled in the art would understand that although the system 200 is described as including the above-described components, in real applications, it is possible to add, remove, and/or replace some of these components and all these modifications or alteration all fall within the scope of the present disclosure.

For example, the system 200 may implement one or more components of the noise reduction system 100 (see FIG. 1), for example by executing one or more computer programs on the CPU 201. The ROM 802, the RAM 803, the storage unit 808, etc. may store the model used by the neural network 108. A microphone connected to the input unit 206 may capture the audio signal 150, and a speaker connected to the output unit 207 may output sound corresponding to the audio signal 172.

FIG. 3 is a flow diagram of a method 300 of audio processing. The method 300 may be implemented by a device (e.g., the system 200 of FIG. 2), as controlled by the execution of one or more computer programs.

At 302, first band gains and a voice activity detection value of an audio signal are generated using a machine learning model. For example, the CPU 201 may implement the neural network 108 to generate the gains 158 and the VAD 160 (see FIG. 1) by processing the band features 156 according to a model.

At 304, a background noise estimate is generated based on the first band gains and the voice activity detection value. For example, the CPU 201 may generate a background noise estimate based on the gains 158 and the VAD 160, as part of operating the Wiener filter 110.

At 306, second band gains are generated by processing the audio signal using a Wiener filter controlled by the background noise estimate. For example, the CPU 201 may implement the Wiener filter 110 to generate the gains 162 by processing the band features 156 as controlled by the background noise estimate (see 304). For example, when the number of noise frames exceeds a threshold (e.g., 50 noise frames) for a particular band, the Wiener filter generates the second band gains for that particular band.

At 308, combined gains are generated by combining the first band gains and the second band gains. For example, the CPU 201 may implement the gain combination block 112 to generate the gains 164 by combining the gains 158 (from the neural network 108) and the gains 162 (from the Wiener filter 110). The first band gains and the second band gains may be combined by multiplication. The first band gains and the second band gains may be combined by selecting a maximum of the first band gains and the second band gains for each band. Limiting may be applied to the combined gains. The first band gains and the second band gains may be combined by multiplication or by selecting a maximum for each band, and limiting may be applied to the combined gains.

At 310, a modified audio signal is generated by modifying the audio signal using the combined gains. For example, the CPU 201 may implement the signal modification block 116 to generate the modified bin features 168 by modifying the bin features 154 using the gains 166.

The method 300 may include other steps similar to those described above regarding the noise reduction system 100. A non-exhaustive discussion of example steps includes the following. A windowing step (cf. the windowing block 102) may be performed on the audio signal as part of generating the inputs to the neural network 108. A transform step (cf. the transform block 104) may be performed on the audio signal to convert time domain information to frequency domain information as part of generating the inputs to the neural network 108. A bins-to-bands conversion step (cf. the band features analysis block 106) may be performed on the audio signal to reduce the dimensionality of the inputs to the neural network 108. A bands-to-bins conversion step (cf. the band gains to bin gains block 114) may be performed to convert band gains (e.g., the gains 164) to bin gains (e.g., the gains 166). An inverse transform step (cf. the inverse transform block 118) may be performed to transform the modified bin features 168 from frequency domain information to time domain information (e.g., the audio frames 170). An inverse windowing step (cf. the inverse windowing block 120) may be performed to reconstruct the audio signal 172 as an inverse of the windowing step.

Model Creation

As discussed above, the model used by the neural network 108 (see FIG. 1) may be trained offline, then stored and used by the noise reduction system 100. For example, a computer system may implement a model training system to train the model, for example by executing one or more computer programs. Part of training the model includes preparing the training data to generate the input features and target features. The input features may be calculated by the band feature calculation of noisy data (X). The target features are composed of ideal band gains and a VAD decision.

The noisy data (X) may be is generated by combining clean speech (S) and noise data (N).

X=S+N

The VAD decision may be based on analysis of the clean speech S. In one implementation, the VAD decision is determined by an absolute threshold of energy of the current frame. Other VAD methods may be used in other implementations. For example, the VAD can be manually labelled.

The ideal band gain g is calculated by:

$${g}_{b} = \sqrt{\frac{{E}_{s} ( b )}{{E}_{x} ( b )}}$$

In the above equation, Eₛ(b) is the band b's energy of clean speech while Eₓ(b) is the band b's energy of noisy speech.

In order to make the model robust to different use cases, the model training system may perform data augmentation on the training data. Given an input speech file with Sᵢ and Nᵢ, the model training system will change Sᵢ and Nᵢ before mixing the noisy data. The data augmentation includes three general steps.

The first step is to control of the amplitude of the clean speech. A common problem for noise reduction models is that they suppress low volume speech. Thus, the model training system performs data augmentation by preparing training data containing speech with various amplitudes.

The model training system sets a random target average amplitude ranging from −45 dB to 0 dB (e.g., −45, −40, −35, −30, −25, −20, −15, −10, −5, 0). The model training system modifies the input speech file by the value a to match the target average amplitude.

Sₘ=a*Sᵢ

The second step is to control the signal to noise ratio (SNR). For each combination of speech file and noise file, the model training system will set a random target SNR. In one implementation, the target SNR is randomly chosen from a set of SNRs [−5, −3, 0, 3, 5, 10, 15, 18, 20, 30] with equal probability. Then the model training system modifies the input noise file by the value b to make the SNR between Sₘ and Nₘ match the target SNR:

Nₘ=b*Nᵢ

The third step is to limit the mixed data. The model training system first calculates the mixed signal Xₘ by:

Xₘ=(Sₘ+Nₘ)

In the event of clipping (e.g., when saving Xₘ as a .wav file in 16-bit quantization), the model training system calculates the maximal absolute value of Xₘ, noted as Aₘₐₓ.

Then a modification ratio c can be calculated by:

c=32767/Aₘₐₓ

In the above equation, the value 32,767 results from 16-bit quantization; this value may be adjusted as needed for other bit quantization precisions.

Then:

S=c*Sₘ

N=c*Nₘ

S and N will be mixed to noisy speech X:

X=S+N

The calculation of average amplitude and SNR may be performed according to various processes, as desired. The model training system may use a minimal threshold to remove the silence segments before calculating the average amplitude.

In this manner, data augmentation is used to increase the variety of the training data, by using a variety of target average amplitudes and target SNRs to adjust a segment of training data. For example, using 10 variations of the target average amplitude and 10 variations of the target SNR gives 100 variations of a single segment of training data. The data augmentation need not increase the size of the training data. If the training data is 100 hours prior to data augmentation, the full set of 10,000 hours of the augmented training data need not be used to train the model; the augmented training data set may be limited to a smaller size, e.g. 100 hours. More importantly, the data augmentation will increase variability in the amplitude and SNR in the training data.

### Implementation Details

An embodiment may be implemented in hardware, executable modules stored on a computer readable medium, or a combination of both (e.g., programmable logic arrays). Unless otherwise specified, the steps executed by embodiments need not inherently be related to any particular computer or other apparatus, although they may be in certain embodiments. In particular, various general-purpose machines may be used with programs written in accordance with the teachings herein, or it may be more convenient to construct more specialized apparatus (e.g., integrated circuits) to perform the required method steps. Thus, embodiments may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. (Software per se and intangible or transitory signals are excluded to the extent that they are unpatentable subject matter.)

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

Various aspects of the present invention may be appreciated from the following enumerated example embodiments (EEEs):
EEE 1. A computer-implemented method of audio processing, the method comprising:
generating first band gains and a voice activity detection value of an audio signal using a machine learning model;
generating a background noise estimate based on the first band gains and the voice activity detection value;
generating second band gains by processing the audio signal using a Wiener filter controlled by the background noise estimate;
generating combined gains by combining the first band gains and the second band gains; and
generating a modified audio signal by modifying the audio signal using the combined gains.
EEE 2. The method of EEE 1, wherein the machine learning model is generated using data augmentation to increase variety of training data.
EEE 3. The method of any one of EEEs 1-2, wherein generating the first band gains and the voice activity detection value is performed using one of a full connected neural network, a recurrent neural network, and a convolutional neural network.
EEE 4. The method of any one of EEEs 1-3, wherein generating the first band gains includes limiting the first band gains using at least two different limits for at least two different bands.
EEE 5. The method of any one of EEEs 1-4, wherein generating the background noise estimate is based on a number of noise frames exceeding a threshold for a particular band.
EEE 6. The method of any one of EEEs 1-5, wherein generating the second band gains includes using the Wiener filter based on a stationary noise level of a particular band.
EEE 7. The method of any one of EEEs 1-6, wherein generating the second band gains includes limiting the second band gains using at least two different limits for at least two different bands.
EEE 8. The method of any one of EEEs 1-7, wherein generating the combined gains includes:
multiplying the first band gains and the second band gains; and
limiting the combined band gains using at least two different limits for at least two different bands.
EEE 9. The method of any one of EEEs 1-8, wherein generating the modified audio signal includes modifying an amplitude spectrum of the audio signal using the combined band gains.
EEE 10. The method of any one of EEEs 1-9, further comprising:
applying an overlapped window to an input audio signal to generate a plurality of frames, wherein the audio signal corresponds to the plurality of frames.
EEE 11. The method of any one of EEEs 1-10, further comprising:
performing spectral analysis on the audio signal to generate a plurality of bin features and a fundamental frequency of the audio signal,
wherein the first band gains and the voice activity detection value are based on the plurality of bin features and the fundamental frequency.
EEE 12. The method of EEE 11, further comprising:
generating a plurality of band features based on the plurality of bin features, wherein the plurality of band features are generated using one of Mel-frequency cepstral coefficients and Bark-frequency cepstral coefficients,
wherein the first band gains and the voice activity detection value are based on the plurality of band features and the fundamental frequency.
EEE 13. The method of any one of EEEs 1-12, wherein the combined gains are combined band gains that are associated with a plurality of bands of the audio signal, the method further comprising:
converting the combined band gains to combined bin gains, wherein the combined bin gains are associated with a plurality of bins.
EEE 14. A non-transitory computer readable medium storing a computer program that, when executed by a processor, controls an apparatus to execute processing including the method of any one of EEEs 1-13.
EEE 15. An apparatus for audio processing, the apparatus comprising:
a processor; and
a memory,
wherein the processor is configured to control the apparatus to generate first band gains and a voice activity detection value of an audio signal using a machine learning model;
wherein the processor is configured to control the apparatus to generate a background noise estimate based on the first band gains and the voice activity detection value;
wherein the processor is configured to control the apparatus to generate second band gains by processing the audio signal using a Wiener filter controlled by the background noise estimate;
wherein the processor is configured to control the apparatus to generate combined gains by combining the first band gains and the second band gains; and
wherein the processor is configured to control the apparatus to generate a modified audio signal by modifying the audio signal using the combined gains.
EEE 16. The apparatus of EEE 15, wherein the machine learning model is generated using data augmentation to increase variety of training data.
EEE 17. The apparatus of any one of EEEs 15-16, wherein at least one limit is applied when generating at least one of the first band gains and the second band gains.
EEE 18. The apparatus of any one of EEEs 15-17, wherein generating the background noise estimate is based on a number of noise frames exceeding a threshold for a particular band.
EEE 19. The apparatus of any one of EEEs 15-18, wherein the processor is configured to control the apparatus to perform spectral analysis on the audio signal to generate a plurality of bin features and a fundamental frequency of the audio signal, and
wherein the first band gains and the voice activity detection value are based on the plurality of bin features and the fundamental frequency.
EEE 20. The apparatus of EEE 19, wherein the processor is configured to control the apparatus to generate a plurality of band features based on the plurality of bin features, wherein the plurality of band features are generated using one of Mel-frequency cepstral coefficients and Bark-frequency cepstral coefficients, and
wherein the first band gains and the voice activity detection value are based on the plurality of band features and the fundamental frequency.

### REFERENCES

U.S. Patent Application Pub. No. 2019/0378531.
U.S. Pat. Nos. 10,546,593 B2; 10,224,053 B2; 9,053,697 B2.
China Patent Publication Nos. CN 105513605 B; CN 111192599 A; CN 110660407 B; CN 110211598 A; CN 110085249 A; CN 109378013 A; CN 109065067 A; CN 107863099 A.
Jean-Marc Valin, “A Hybrid DSP Deep Learning Approach to Real-Time Full-Band Speech Enhancement”, in 2018 IEEE 20th International Workshop on Multimedia Signal Processing (MMSP), DOI: 10.1109/MMSP.2018.8547084.
Xia, Y., Stern, R., “A Priori SNR Estimation Based on a Recurrent Neural Network for Robust Speech Enhancement”, in Proc. Interspeech 2018, 3274-3278, DOI: 10.21437/Interspeech.2018-2423.
Zhang, Q., Nicolson, A. M., Wang, M., Paliwal, K., & Wang, C.-X., “DeepMMSE: A Deep Learning Approach to MMSE-based Noise Power Spectral Density Estimation”, in IEEE/ACM Transactions on Audio, Speech, and Language Processing, 1-1. DOI:10.1109/taslp.2020.2987441.

1. A computer-implemented method of audio processing, the method comprising:
generating first band gains and a voice activity detection value of an audio signal using a machine learning model;
generating a background noise estimate based on the first band gains and the voice activity detection value;
generating second band gains by processing the audio signal using a Wiener filter controlled by the background noise estimate;
generating combined gains by combining the first band gains and the second band gains; and
generating a modified audio signal by modifying the audio signal using the combined gains.

2. The method of claim 1, wherein the machine learning model is generated using data augmentation to increase variety of training data.

3. The method of claim 1, wherein generating the first band gains includes limiting the first band gains using at least two different limits for at least two different bands.

4. The method of claim 1, wherein generating the background noise estimate is based on a number of noise frames exceeding a threshold for a particular band.

5. The method of claim 1, wherein generating the second band gains includes using the Wiener filter based on a stationary noise level of a particular band.

6. The method of claim 1, wherein generating the second band gains includes limiting the second band gains using at least two different limits for at least two different bands.

7. The method of claim 1, wherein generating the combined gains includes:
multiplying the first band gains and the second band gains; and
limiting the combined band gains using at least two different limits for at least two different bands.

8. The method of claim 1, wherein generating the modified audio signal includes modifying an amplitude spectrum of the audio signal using the combined band gains.

9. The method of claim 1, further comprising:
applying an overlapped window to an input audio signal to generate a plurality of frames, wherein the audio signal corresponds to the plurality of frames.

10. The method of claim 1, further comprising:
performing spectral analysis on the audio signal to generate a plurality of bin features and a fundamental frequency of the audio signal,
wherein the first band gains and the voice activity detection value are based on the plurality of bin features and the fundamental frequency.

11. The method of claim 10, further comprising:
generating a plurality of band features based on the plurality of bin features, wherein the plurality of band features are generated using one of Mel-frequency cepstral coefficients and Bark-frequency cepstral coefficients,
wherein the first band gains and the voice activity detection value are based on the plurality of band features and the fundamental frequency.

12. The method of claim 1, wherein the combined gains are combined band gains that are associated with a plurality of bands of the audio signal, the method further comprising:
converting the combined band gains to combined bin gains, wherein the combined bin gains are associated with a plurality of bins.

13. A non-transitory computer readable medium storing a computer program that, when executed by a processor, controls an apparatus to execute processing including the method of claim 1.

14. An apparatus for audio processing, the apparatus comprising:
a processor; and
a memory,
wherein the processor is configured to control the apparatus to generate first band gains and a voice activity detection value of an audio signal using a machine learning model;
wherein the processor is configured to control the apparatus to generate a background noise estimate based on the first band gains and the voice activity detection value;
wherein the processor is configured to control the apparatus to generate second band gains by processing the audio signal using a Wiener filter controlled by the background noise estimate;
wherein the processor is configured to control the apparatus to generate combined gains by combining the first band gains and the second band gains; and
wherein the processor is configured to control the apparatus to generate a modified audio signal by modifying the audio signal using the combined gains.

15. The apparatus of claim 14, wherein at least one limit is applied when generating at least one of the first band gains and the second band gains.
